(19) United States
(12) Patent Application Publication
(10) Pub. No.: US 2018/0335651 A1
(43) Pub. Date: Nov. 22, 2018

(54) Thermochromic low-emissivity film

(71) Applicant: National Technology & Engineering Solutions of Sandia, LLC, Albuquerque, NM (US)

(72) Inventors: Paul G. Clem, Albuquerque, NM (US); Michael Goldflam, Albuquerque, NM (US); Ting S. Luk, Albuquerque, NM (US); Michael B. Sinclair, Albuquerque, NM (US); Thomas Edwin Beechem, III, Albuquerque, NM (US)

(21) Appl. No.: 15/981,561

(22) Filed: May 16, 2018

Related U.S. Application Data
(60) Provisional application No. 62/507,350, filed on May 17, 2017.

(51) Int. Cl. G02F 1/00; G02F 1/01

(52) U.S. Cl. CPC G02F 1/009; G02F 2203/11; G02F 1/0147

(57) ABSTRACT

Thermochromic low-emissivity films can comprise a vanadium dioxide thin film or a thin film of vanadium dioxide nanoparticles incorporated into a polymer matrix, and a layer comprising a transparent conductive oxide to modify solar heat gain, solar reflectivity and thermal resistance of windows. The thermochromic low-emissivity films transition from infrared (IR) reflective when warm, to IR transparent when cool. This dynamic reflectivity is passive by nature, and requires no electronics or power source to shift. In addition, this dynamic transition can occur at any design temperature, and when the nanoparticles are dispersed, they remain transparent in the visible spectrum during both phases.

### CROSS-REFERENCE TO RELATED APPLICATION

This application claims the benefit of U.S. Provisional Application No. 62/507,350, filed May 17, 2017, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to window coatings and, in particular, to a thermochromic low-emissivity film that dynamically adjusts reflectivity and emissivity with temperature.

### BACKGROUND OF THE INVENTION

The emissivity of a surface measures its effectiveness in emitting energy as thermal radiation. Window glass is by nature highly thermally emissive. To improve thermal control (insulation and solar optical properties), thin film coatings can be applied to the window. Low-e coatings reduce the emission of radiant infrared energy, thus tending to keep heat on the side of the glass where it originated, while letting visible light pass. There are two types of transparent low-e coatings in today's market—semiconductive coatings, such as indium tin oxide (ITO), and metallic coatings, such as silver. Such coatings can be applied by physical vapor deposition, chemical vapor deposition, sol-gel methods, etc. Sputter-deposited silver-based coatings, with emissivities of 2-8%, represent the majority of the current low-e market. Silver-based low-e coatings are available as single-silver, double-silver, and triple-silver products. Triple-silver stacks have the highest selectivity of visible light transparency (VLT) and low infrared (IR) emissivity, with an emissivity of about 0.022, but are also the most expensive.

Single-pane windows still make up about 40% of all window glass in the southern states, and nearly 30% in the midwest and northern states. These high percentages account for significant energy loss when heating energy is considered, and even more when air-conditioning is considered. The dominant technology at present for energy efficient windows is double-pane “insulated” glass with low-e coatings. Unfortunately, the return on investment (ROI) to replace single-pane windows with double-pane windows, in terms of energy savings, averages over 20 years. This is generally not considered a good investment and, as a result, the single-pane window stock is only diminishing by about 2% per year. A low-cost retrofit system could produce significant savings for consumers (˜$12 billion/year) and significantly reduce our national energy consumption and CO₂ production.

### SUMMARY OF THE INVENTION

The present invention is directed to a thermochromic low-emissivity film comprising a layer comprising vanadium dioxide (VO₂), wherein the VO₂ undergoes a metal-insulator transition at a thermochromic transition temperature, such that the layer transmits infrared radiation below the thermochromic transition temperature and reflects infrared radiation above the thermochromic transition temperature, and a layer comprising a transparent conductive oxide (TCO), wherein the thermochromic low emissivity film has an emissivity of less than 0.4 at a wavelength of 10 microns. The layer comprising VO₂ can comprise a thin film of VO₂ having a film thickness less than 300 nm or a film comprising a plurality of less than 300 nm VO₂ nanoparticles dispersed in a first transparent polymer matrix. The VO₂ nanoparticles can be doped. For example, the dopant can comprise tungsten, niobium, tantalum, molybdenum, titanium, zirconium, hafnium, magnesium, copper, nickel, cobalt, chromium, aluminum, hydrogen, lithium, scandium, yttrium, germanium, or silicon. The doping can change the thermochromic transition temperature from between about −15° C. to 80° C. The layer comprising a TCO can comprise a thin film of the TCO or a film comprising a plurality of TCO nanoparticles dispersed in a second transparent polymer matrix. For example, the TCO can comprise In₂O₃, (In,Sn)₂O₃ (ITO), fluorine-doped SnO₂, SnO₂, ZnO, CdO, Ga₂O₃, or (Ga,In,Zn)₂O₃, with a plasma wavelength longer than 800 nm. The invention can further comprise a thermally insulating polymer layer between the VO₂ and TCO layer. The polymer matrices/layer can be transparent from 0.4 μm to 2.5 μm wavelength. For example, the polymer matrices/layer can comprise polyester, polyether, polyimide, polystyrene, or polyurethane.

The thermochromic low-emissivity films of the present invention can combine a low U-Value film with dynamic IR transmission in winter for residential heating and IR rejection in summer to reduce cooling loads, at a price point similar to low-e coatings. In particular, the invention can: 1) reduce energy loss through existing windows, 2) be easily applied by existing window film installers, 3) open new markets for window films that do not exist today, 4) guarantee a usable lifespan of more than 10 years, 5) deliver undistorted transparent views from the inside-out, 6) offer customers a realistic ROI through energy savings with increased comfort, 7) minimize internal condensation associated with static low-e films, and 8) reduce overall CO₂ production. In addition to windows, the thermochromic films can have applications for paint, shingles, and textiles, for example.

### BRIEF DESCRIPTION OF THE DRAWINGS

The detailed description will refer to the following drawings, wherein like elements are referred to by like numbers.

FIG. 1 is a graph of the energy distribution of sunlight as a function of wavelength.

FIGS. 2(a) and 2(b) are graphs of the index of refraction and absorption for VO₂ below and above its metal-insulator transition temperature T_{c}, demonstrating environmental temperature-controlled infrared limiting.

FIGS. 3(a) and 3(b) illustrate the basic concept of a thermochromic pigment window film.

FIG. 4 is a graph of the conductivity of undoped VO₂ in the infrared.

FIG. 5 is a graph of emissivity above and below the transition temperature for large and small particles.

FIG. 6 is a schematic illustration of a thermochromic low-emissivity film comprising a layer of vanadium dioxide nanoparticles dispersed in a transparent polymer matrix on top of a thin film of a transparent conductive oxide.

FIG. 7 is a schematic illustration of composite film comprising vanadium dioxide nanoparticles and transparent conductive oxide nanoparticles dispersed in a transparent polymer matrix.

FIG. 8(a) is an absorption spectrum for a VO₂ film directly atop an ITO film at a temperature below the transition temperature. FIG. 8(b) is a reflection spectrum for VO₂/ITO bilayer. FIG. 8(c) is a transmission spectrum for VO₂/ITO bilayer.

FIG. 9(a) is an absorption spectrum for a VO₂ film directly atop an ITO film at a temperature above the transition temperature. FIG. 9(b) is a reflection spectrum for VO₂/ITO bilayer. FIG. 9(c) is a transmission spectrum for VO₂/ITO bilayer.

FIG. 10 is a schematic illustration of a thermochromic low-emissivity film comprising a thin film of vanadium dioxide on top of a thermally insulating polymer layer on top of a thin film of a transparent conductive oxide.

FIG. 11(a) is an absorption spectrum for a VO₂ film directly atop a polymer layer on a ITO film at a temperature below the transition temperature. FIG. 11(b) is a reflection spectrum for VO₂/polymer/ITO multilayer. FIG. 11(c) is a transmission spectrum for VO₂/polymer/ITO multilayer.

FIG. 12(a) is an absorption spectrum for a VO₂ film directly atop a polymer layer on a ITO film at a temperature above the transition temperature. FIG. 12(b) is a reflection spectrum for VO₂/polymer/ITO multilayer. FIG. 12(c) is a transmission spectrum for VO₂/polymer/ITO multilayer.

FIGS. 13(a) and 13(b) are scanning electron microscopy images of low polydispersity VO₂ nanoparticles.

FIG. 14(a) is a graph of resistance versus temperature showing tungsten doping of VO₂ to move the transition T_{c} to a 30° C. transition temperature. FIG. 14(b) illustrates visible transmission but environmentally-controlled infrared limiting (70-90% decrease above T_{c}) in doped VO₂ thermochromic films. Artifacts at 800 nm and 1900 nm wavelengths are due to automated filter changes in the UV-Vis-NIR spectrophotometer.

FIGS. 15(a), 15(b), and 15(c) show transmission electron microscopy (TEM), differential scale calorimetry (DSC), and optical transmission of multiply doped VO₂ nanoparticles.

### DETAILED DESCRIPTION OF THE INVENTION

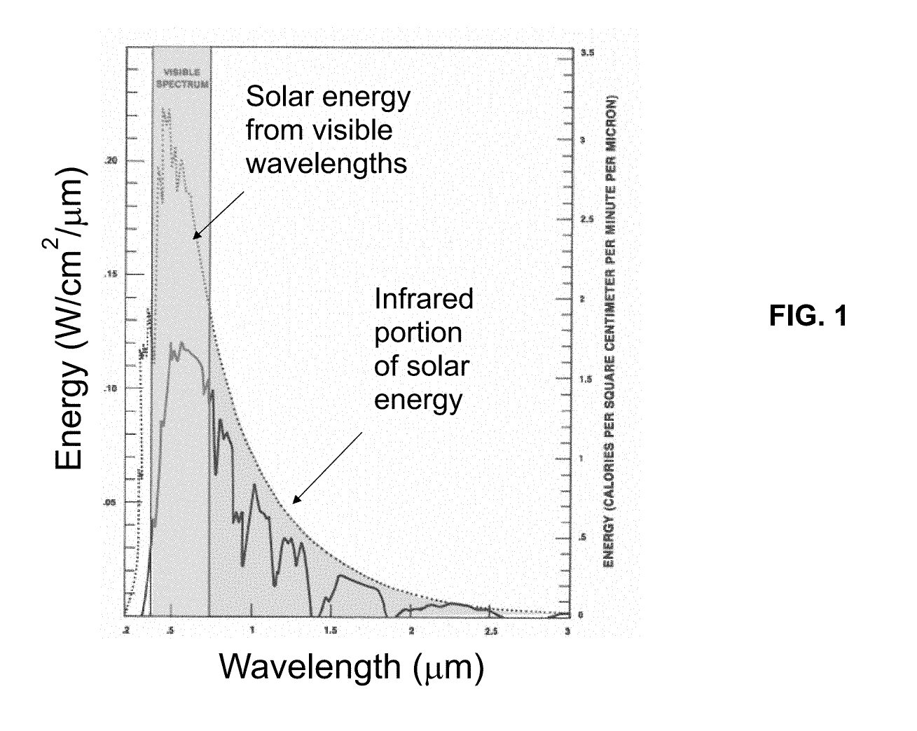

FIG. 1 shows the energy distribution of sunlight as a function of wavelength. See E. Mazria, The Passive Solar Energy Handbook, Rodale Books (1979). Most of the solar energy (58%) is in the IR portion of the spectrum. Engineering of the solar illumination (light) and thermal gain (heat) can greatly improve energy efficiency and comfort. In particular, the goal of a thermochromic window is to decouple the visible light from the infrared radiation (heat gain). This can be achieved by dynamically blocking the solar near-infrared radiation (λ=0.8-2.5 μm) and having a temperature tunable emissivity of long-wavelength infrared radiation (λ=8-12 μm).

The present invention is directed to low cost, thermally dynamic, low emissivity bilayer films that can be incorporated into flexible window coatings to modify solar heat gain, solar reflectivity and thermal resistance in windows. The bilayer films can comprise a layer comprising a vanadium dioxide (VO₂) film or VO₂ nanoparticles dispersed in a transparent polymer matrix and a transparent conductive oxide (TCO) film or TCO nanoparticles dispersed in a transparent polymer matrix. The VO₂ film or nanoparticles can transition from IR reflective when warm, to IR transparent when cool. This dynamic reflectivity is passive by nature, and requires no electronics or power source to shift. In addition, this dynamic transition can occur at any design temperature, and when the nanoparticles are dispersed, they remain transparent in the visible spectrum during both phases. The thermochromic low emissivity film can reduce the U-Value (inverse of the total thermal resistance) of single-pane windows and take advantage of solar gain by automatically reflecting heat away when it's hot outside, and allowing heat in when it's cold outside. Although the invention is described as a thermochromic low emissivity coating for windows, the invention also has applications for thermochromic paints, shingles, and textiles (clothing), for example.

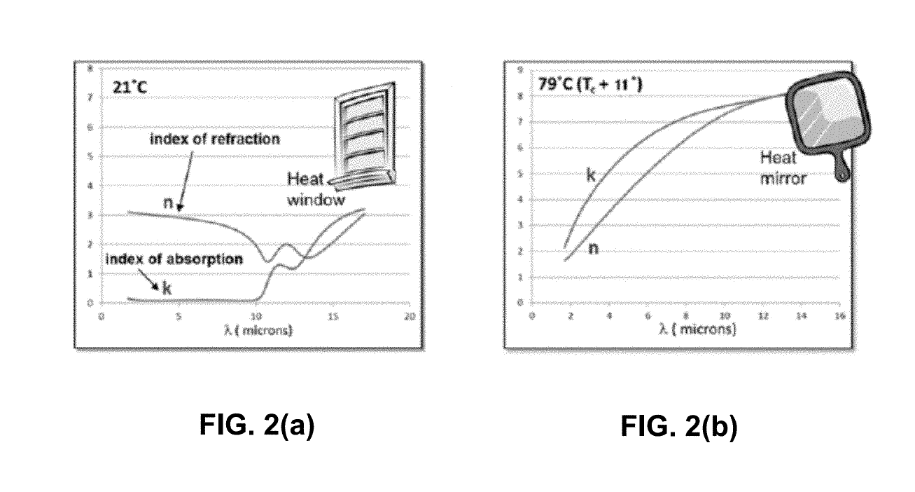

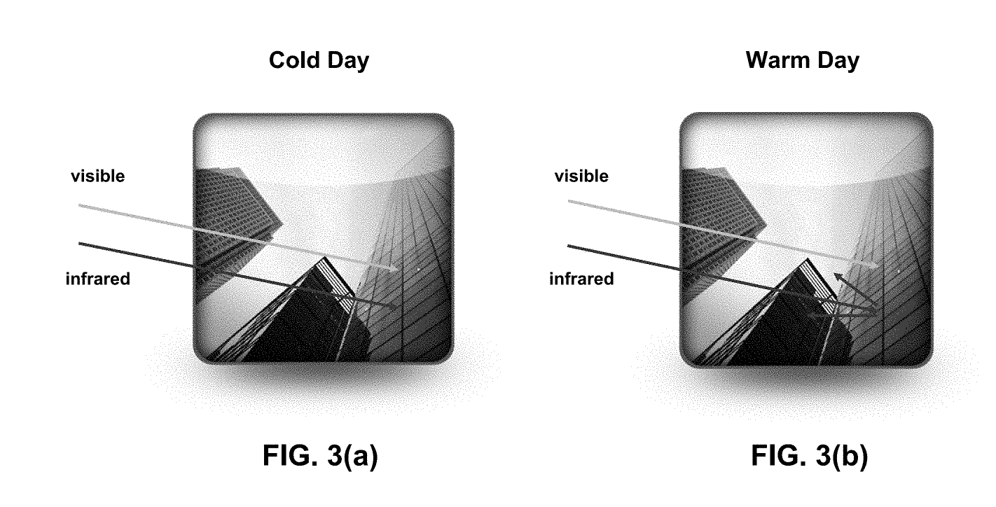

As shown in FIGS. 2(a) and 2(b), there is a dramatic difference between refractive index n and index of absorption k below (n˜3, k<0.1) and above (k>n) the natural VO₂-M to VO₂—R phase transition temperature of T_{c}=68° C. This results in a strong decrease in transmitted infrared light above the thermochromic transition temperature. On cold days, a VO₂-coated window transmits visible light and infrared radiation (i.e., solar heat) and has a low emissivity, as shown in FIG. 3(a). Conversely, on hot days, the window transmits visible light, but infrared radiation is reflected due to a high reflectivity, as shown in FIG. 3(b). These dynamic films offer substantial improvement over “always on” reflective low-e coatings. In particular, the invention enables single-pane window glass to perform as well or better than double-pane insulated windows, with U-Value <0.50, haze <2%, visible light transmission (VLT)>70, and an installed price $4/sf.

Thermochromic Vanadium Dioxide Films and Nanoparticles

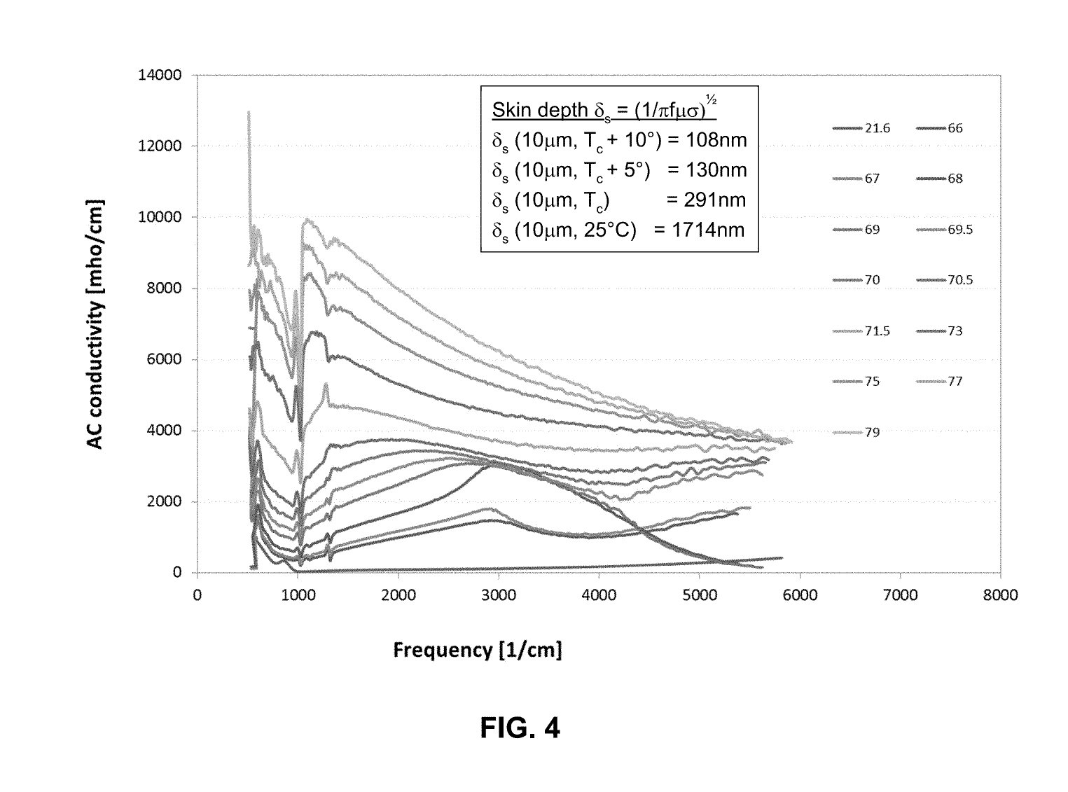

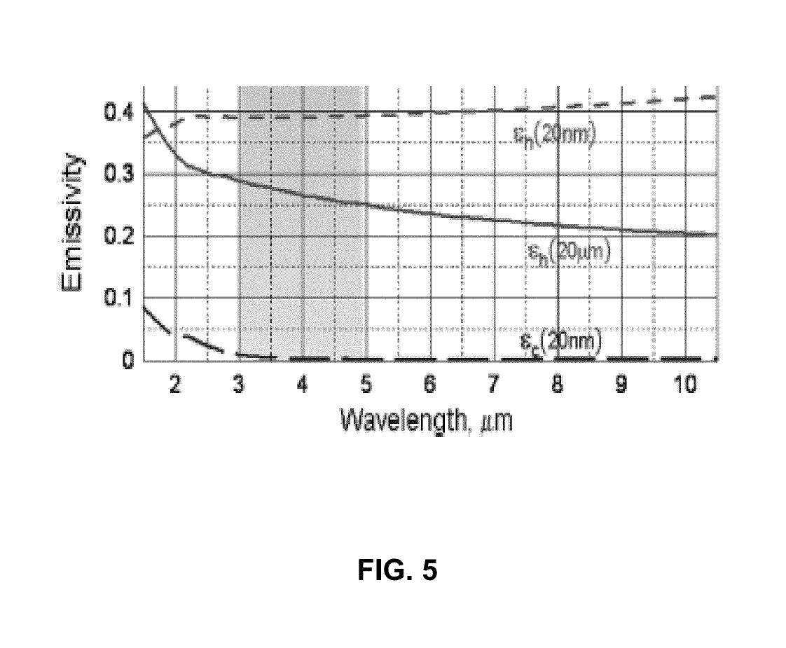

The thermochromic nanoparticles can be smaller than the effective medium limit for scattering (˜λ/3n, or 50 nm for 450 nm light, and VO₂ refractive index of 3), to enable scattering/haze-free aftermarket thermochromic window films. FIG. 4 shows the far-infrared (λ=8-12 μm) conductivity of undoped VO₂, resulting from the dramatic change in skin depth δₛ as a function of temperature. For example, the skin depth is δₛ=291 nm at the transition temperature. At 25° C. the skin depth δₛ=1714 nm, and at 77° C. the skin depth δₛ=108 nm. This skin depth dependence also implies that the tunability of the hot emissivity will be a function of VO₂ particle size. FIG. 5 shows the emissivity above (ch) and below (cc) the transition temperature for large (20 μm) and small (20 nm) particles. As expected, the hot emissivity tunability decreases with particle size as the particle size exceeds the skin depth. Therefore, the change in emissivity is strongest for particle sizes or film thicknesses of order the skin depth, but decreases significantly for larger sizes or thicknesses.

Vanadium dioxide is potentially a low-e, high transparency alternative to silver. Further, when the low emissivity VO₂ film/nanoparticle layer is combined with a TCO film/nanoparticle layer, a very low emissivity film with a tunable solar heat gain coefficient can be realized. For example, the most desirable solar region to tune is the solar infrared portion between 800 nm to 2.5 microns, while keeping emissivity high from 5-15 microns. Therefore, the low emissivity VO₂ nanoparticles can be combined with a TCO film/nanoparticles that have a plasma wavelength between 800 nm and 2.5 microns to make a very low emissivity film with a large tunable solar heat gain coefficient. (The plasma wavelength occurs at the crossover in the infrared from high transmission at shorter wavelengths to high reflection at longer wavelengths). The tunable emissivity bilayer can have an emissivity less than 0.4 to greater than 0.5-0.8 for emissivity-based cooling.

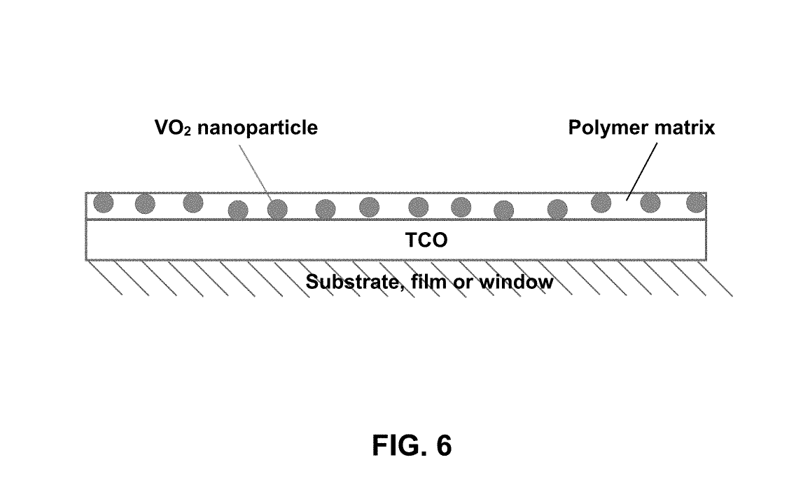

As an example, FIG. 6 shows a bilayer coating comprising a layer of VO₂ nanoparticles dispersed in a transparent polymer matrix deposited on top of a thin TCO film. Alternatively, the bilayer coating can comprise a thin VO₂ film on top of a layer comprising a thin TCO film or TCO nanoparticles dispersed in a transparent polymer matrix. Alternatively, the bilayer coating can comprise a TCO film/nanoparticle layer atop a VO₂ film/nanoparticle layer. Preferably, the nanoparticles have a particle size of less than about 300 nm and, more preferably, less than 100 nm. Preferably, the polymer matrix is transparent between about 0.4 and 2.5 μm wavelength. For example, the polymer matrix can comprise a polyester, polyether, polyimide, polystyrene, or polyurethane. For example, the TCO film/nanoparticles can comprise In₂O₃, (InSn)₂O₃ (ITO), fluorine-doped SnO₂ (FTO), SnO₂ (TO), ZnO, CdO, Ga₂O₃, or (Ga,In,Zn)₂O₃. The TCO film/nanoparticles can have a plasma wavelength greater than 800 nm. The coatings can be applied to a rigid substrate, such as glass, or a flexible substrate, such as Mylar or a textile.

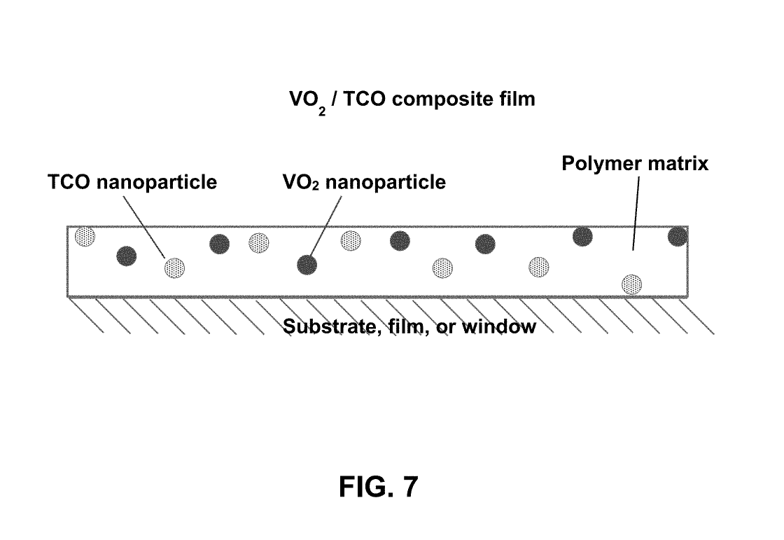

Alternatively, the low emissivity coating can comprise a composite film comprising a mixture of VO₂ and TCO nanoparticles dispersed in a transparent polymer matrix, as shown in FIG. 7. The nanoparticles can also have a particle size of less than 300 nm. The TCO nanoparticles can comprise ITO, In₂O₃, FTO, TO, ZnO, CdO, Ga₂O₃, or (Ga,In,Zn)₂O₃.

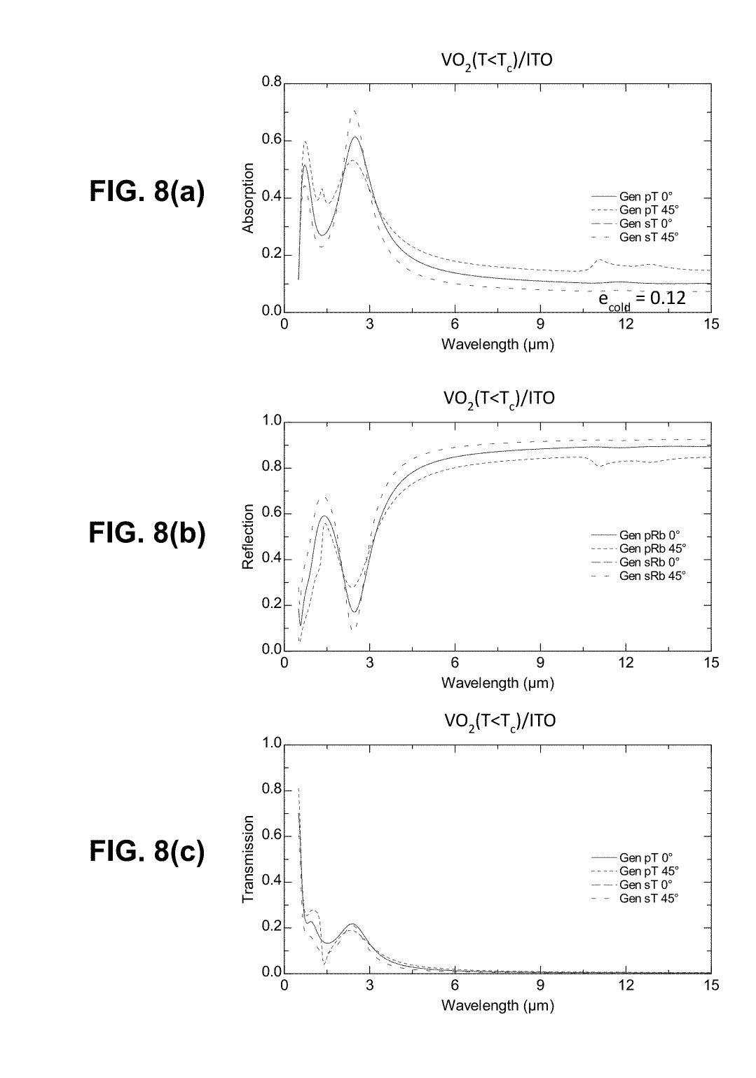

FIGS. 8(a)-(c) show spectra for 100-nm-thickness VO₂ film on 200-nm thickness ITO film below the transition temperature (T<T_{c}). As shown in FIG. 8(a), the cold emissivity of a single layer of VO₂ is about ecoid=0.12.

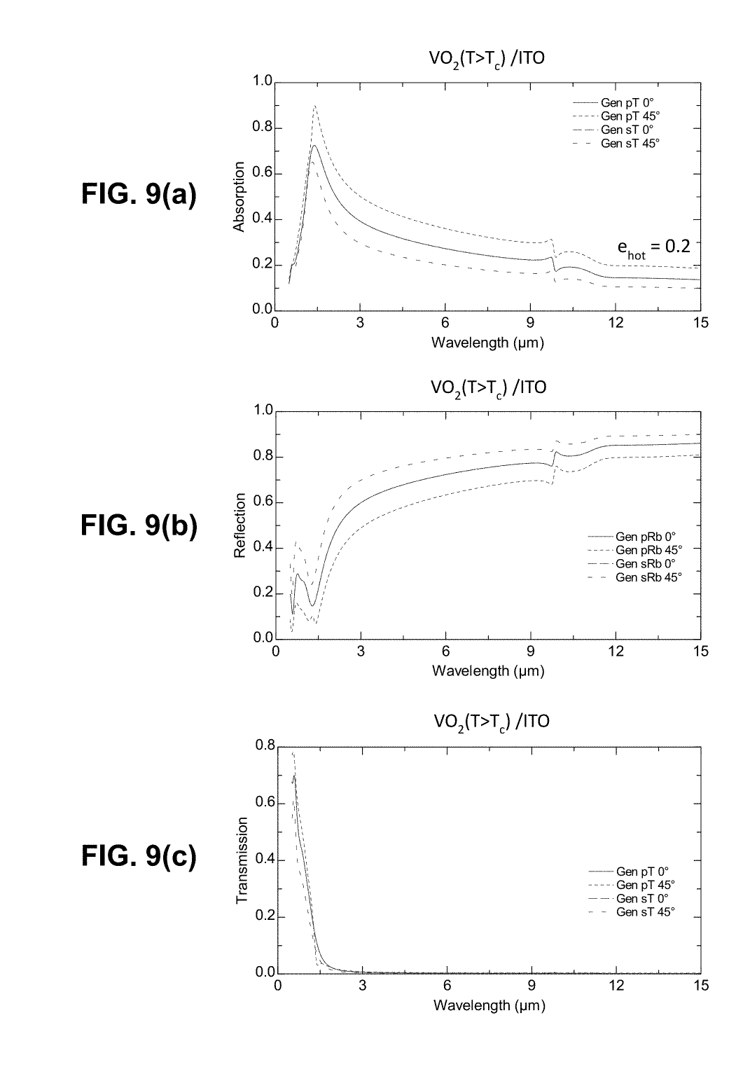

FIGS. 9(a)-(c) show comparable spectra for VO₂/ITO coatings above the transition temperature (T>T_{c}). As shown in FIG. 9(a), the emissivity nearly doubles above the transition temperature, eₕₒₜ=0.2. As shown in FIG. 9(b), reflectivity in the IR remains relatively high. As shown in FIG. 9(c), light transmission in the visible portion of the spectrum is also high, with negligible transmission in the IR.

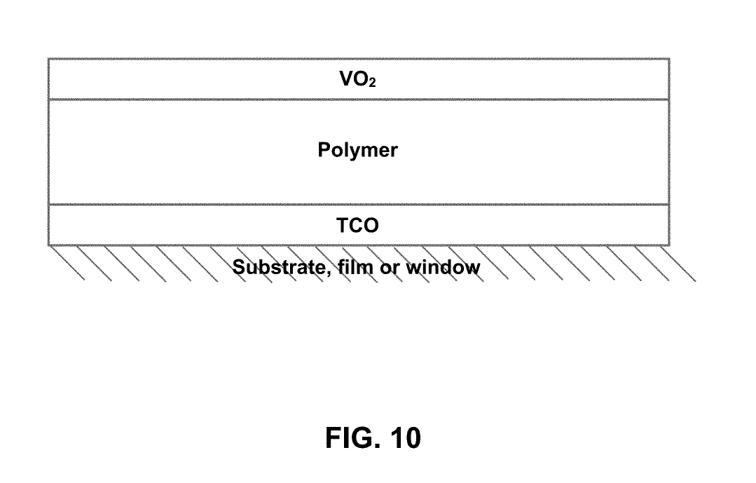

The tunability of the emissivity can be further aided by a multilayer construction. For example, a temperature-dependent VO₂ film can be coated on a transparent, thermally insulating layer on top of a TCO layer, facilitating switching of emissivity from low to high in response to changes in the environmental temperature. For example, the thermally insulating layer can be a transparent polymer layer between an outer layer comprising vanadium dioxide and the bottom layer comprising a transparent conductive oxide layer, as shown in FIG. 10. For example, the transparent polymer layer can be between 0.2 microns and 3 microns in thickness and can be transparent from 0.4 μm to 2.5 μm wavelength. For example, the transparent polymer layer can comprise polyester, polyether, polyimide, polystyrene or polyurethane.

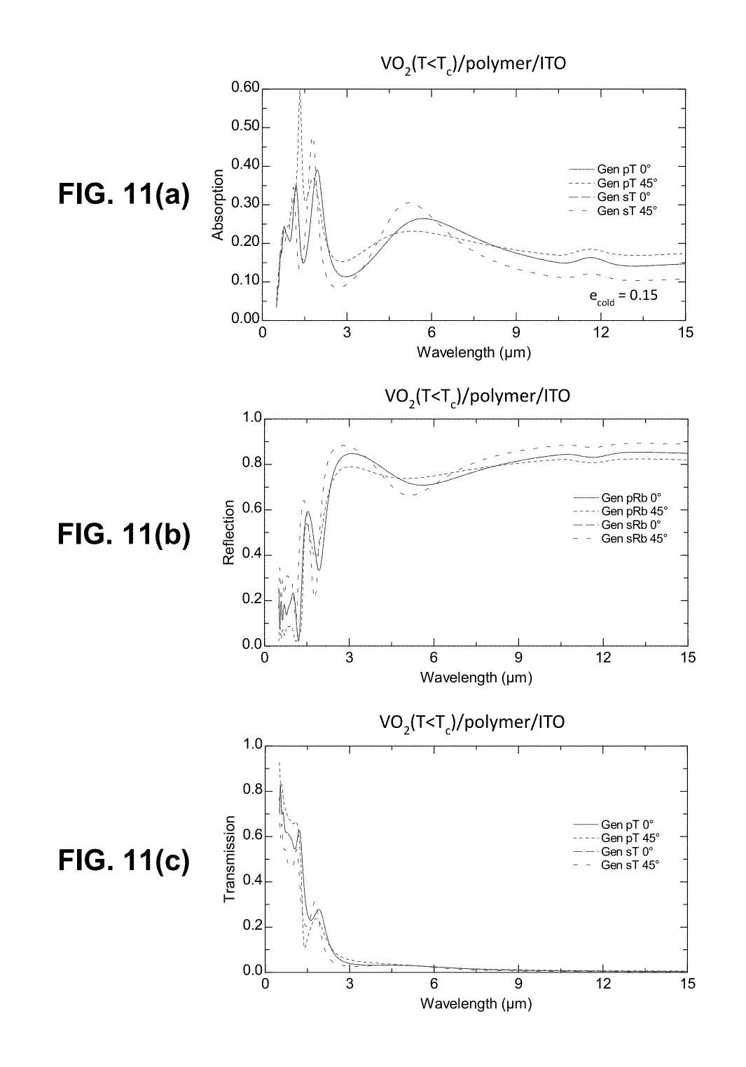

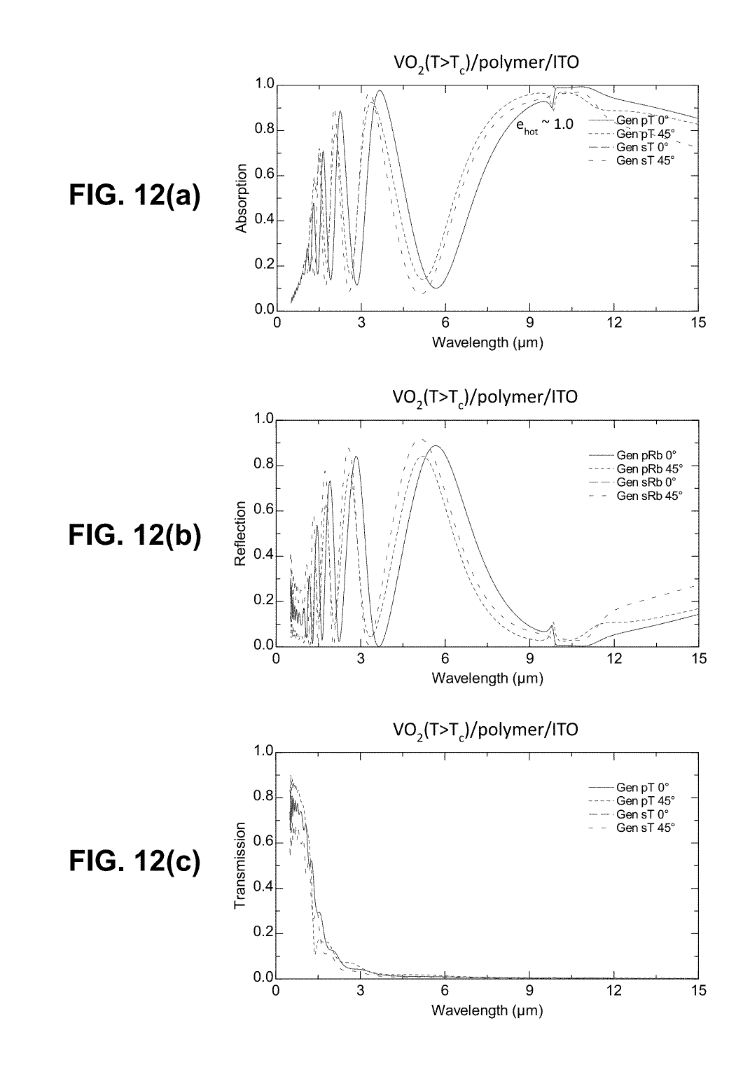

FIGS. 11(a)-(c) show spectra for VO₂ coatings on a polymer layer on top of an ITO layer below the transition temperature (T<T_{c}). The cold emissivity of this multilayer coating is about ecoid=0.15. FIGS. 12(a)-(c) show comparable spectra for VO₂/polymer/ITO multilayer above the transition temperature (T>T_{c}). The emissivity is nearly unity at high temperature due to the VO₂ transition and the presence of the insulating thermal barrier layer. Due to the high absorption, the IR reflectance drops, as shown in FIG. 12(b). However, the VLT remains high at 60-80%, as shown in FIG. 12(c).

Thermochromic Nanoparticle Synthesis, Milling and Film Integration

Monolithic films of doped VO₂ can be grown directly on glass by sputtering or chemical vapor deposition. However, these methods may be impractical for the aftermarket window film market. For these markets, nanoparticle fillers (SiO₂, TiO₂, silver) are widely used to provide UV absorption or other passive optical properties to commercially available polymer-based window films. However, no commercial nanoparticle VO₂/polymer window films are known to be currently available. While thermochromic VO₂ research has been an area of interest since the 1970s, the difficulty in preparing phase-pure VO₂, and not alternate phases such as V₂O₅ (opaque) or V₆O₁₁/V₂O₃ (semiconducting, gray), has contributed to difficulty with commercialization and quality control. In addition, very fine particle sizes ˜50 nm that are well-dispersed are required to limit optical scattering/haze in composites.

Thermochromic nanoparticle preparation and dispersion involves (1) precipitation of a spherical precursor compound, (2) collection and purification of these precursor materials, (3) calcination in a controlled atmosphere to form V₂O₃, and (4) a thermal anneal in controlled atmosphere to oxidize the powder to the desired VO₂—R rutile structure, phase-pure thermochromic pigment. Materials processing for product engineering entails (5) milling for particle size control and optimal optical scattering performance with (6) surface modification for effective dispersion within the film matrix, and (7) film production operations to mass produce the product composite material. Performance characterization and validation can be conducted through these processing stages including particle size determination, XRD crystalline phase identification, TGA/DTA for thermochromic quality, FTIR for surface modification, and visible to IR optical property characterization vs. temperature for the final film to optimize engineering variables such as pigment loading, transmittance/reflectance, solar modulation, and thermal gain.

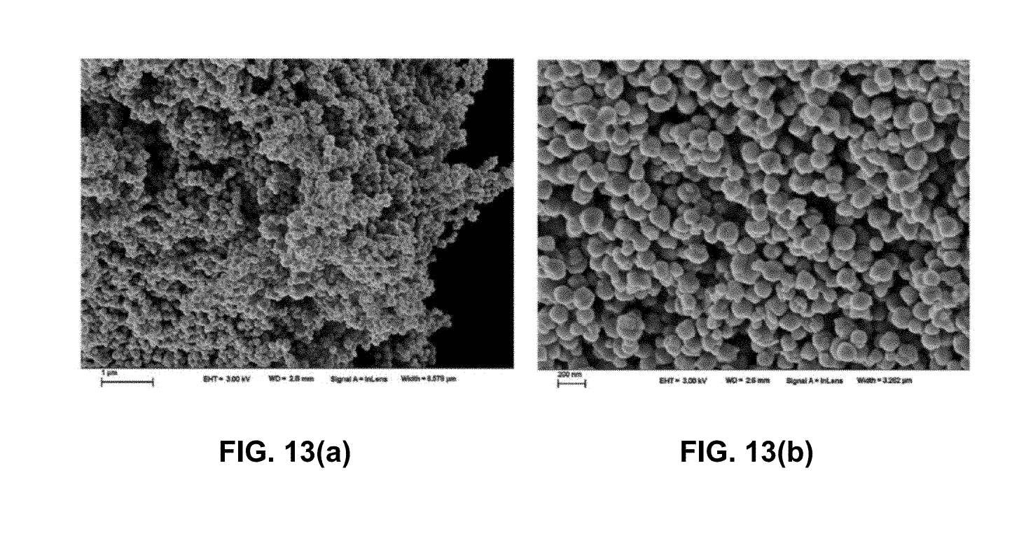

The process currently being used for producing the vanadium organic precursor (VOP) is a facile approach based on the mixing of alkoxide precursors (V and dopants) in pyridine to an acetone solution with controlled water content, to initiate the precipitation of round particles of the nominal composition V₂O₅ₓPy_{y}H₂O (where x≈0.8 and y≈0.9). See Y. Li et al., ACS Nano 4, 3325 (2010); J. Leonard et al., Macromolecules 45, 671 (2012); and D. Kunz et al., ACS Nano 7(5), 4275 (2013). Particle size is controlled by nucleation rate, and is directly influenced by the water content used for destabilization. The reaction of alkoxide precursors with wet solution is rapid. Scale-up operations are possible with a continuous flow system, controlling addition rates of volumetric feedstock for reaction and collection by a high-volume filter press for recovery of VOP material. Once recovered and dried, the VOP material is calcined under reducing conditions to form V₂O₃ particles, and further oxidized under low pO₂ conditions to transform the material to the desired active VO₂—R (rutile, metallic) high temperature phase, with the thermal phase transition to VO₂-M (monoclinic, transparent) at room temperature. Mass transport in VO₂ at 500° C. is expected to result due to surface diffusion during annealing. See C. D. Landon et al., Appl. Phys. Lett. 107, 023108 (2015). This leads to morphology variation and sintering in films and aggregates of particles. Processing operations, including milling, are required to prepare the pigment for composite film manufacture. See S. Yamamoto et al., Proc. Mater. Res. Soc. Symp. 879E (2005); S. Wang et al., J. Mater. Chem. 2 (17), 6365 (2011); S. Yamamoto et al., Chem. Mater. 21, 198 (2009); Y. Gao et al., In Nanofabrication, Masuda, Y., Ed. (2011); and K. Sato et al., J. Am. Ceram. Soc. 91(8), 2481 (2008). Two methods to mitigate these issues are processing atmosphere control to enable significantly decreased annealing times. Examples of particles formed using this processing route are shown in FIGS. 13(a) and 13(b), without any milling of the thermochromic nanoparticles. A fluidized bed reactor can both increase kinetics of annealing/oxidation (increased production rate) and separate particles during this annealing step to prevent initial formation of aggregates, minimizing the need for subsequent processing. In particular, a fluid-bed reaction annealing technique enables larger batch size and can produce 50 nm to 100 nm spherical, unagglomerated VO₂ particles. This technique by nature is scalable and can be used in larger production scenarios.

Effective dispersion of the nanoparticles is necessary for control of optical properties in the final film. Li et al. calculated that VO₂ nanoparticles incorporated into composite films can provide improvements in luminous transmittance and enhanced transmittance modulation of solar energy. VO₂—R exhibits a strong plasmon resonance in the near infrared, whereas VO₂-M has no resonance. An assumption in these calculations is that the size of the particles is much smaller than the wavelength of interest, meaning that for IR spectral response, the particles should be dispersed below 100 nm effective sizes. See J. Zheng et al., Powder Technol. 91(3), 173 (1997). Mie theory provides an adequate approximation for the scattering efficiencies of VO₂—R particles, and analytical solutions are available from the utility, ‘Mieplot’. See M. Z. He et al., Powder Technol. 161(1), 10 (2006). The particle size and optical properties of the VO₂—R rutile phase most strongly affect the optical transmission of a nanoparticle film. For small nanoparticles, absorption plays a dominant role in transmission. As particle size increases above 100 nm, scattering properties become more dominant. Bai et al. calculated optical properties for 200 nm spheres of either solid or aggregated nanoparticles; to first approximation, the VO₂-M phase scatters more strongly for particle-size distribution (PSD)<300 nm, and VO₂—R particles scatter more for PSD>300 nm. See H. Bai et al., Nanotechnology 20(8), 085607 (2009).

Mechanical milling procedures are needed for many materials produced by chemical precipitation routes and calcination. Surface diffusion and bonding between particles is common for powder bed transformations in ceramics, and necessitate the grinding of powders to equiaxed materials. An attritor mill combines forces of impact, abrasion, and shear between particles during the rotation of media with the stirring arms. Finer particles experience cleavage and abrasion by compressive forces and shear. See K. Sato et al., J. Am. Ceram. Soc. 91(8), 2481 (2008). The specific energy input to the system can be monitored and evaluated with particle size measurements to optimize the size and dispersion of the pigment particles during milling operations. Wet milling is energetically more favorable, and can be promoted by the control of solution conditions and dispersant loading. See S. Yamamoto et al., Mater. Res. Soc. Symp. Proc., 879E (2005); S. Wang et al., J. Mater. Chem. 21(17), 6365 (2011); S. Yamamoto et al., Chem. Mater. 21, 198 (2009); and Y. Gao et al., In Nanofabrication, Masuda, Y., Ed. (2011). Obtaining dispersion of two phases requires the development of repulsive forces between the highly divided phase and the continuous matrix phase. Covalent bonding to the particle surface is readily achieved using silane coupling agents, and a variety of terminal organic structures are available to control particle dispersion. During the milling operation, a silane coupling agent and/or co-dispersant can be added as the particle size is reduced, to coat the increasing surface area and enable dispersion in the polymer matrix in the drawn sheet form. The pigment can be recovered in post-milling operations and stored for compounding operations in the final composite formation stage.

The thermochromic VO₂-polymer composite film can comprise fine (20-50 nm) nanoparticles dispersed within a transparent polymer matrix. For example, the VO₂ nanoparticles can be dispersed within UV-curable hard coatings. These are one-component (1K) systems that cure by photoinitiated polymerization of the acrylate monomers and oligomers. As they do not contain solvents, dispersion of the hydrophilic particles into the matrix is straightforward and curing is instantaneous. The UV-curable formulations typically contain an acrylated oligomer based on a polyester (polyethers are also occasionally used). Alternatively, the VO₂ particles can be dispersed within an acrylic urethane adhesive layer. This resin system has superior versatility, durability, appearance and superior weatherability compared to other resin systems. The most common coating type is two-component (2K), where an acrylic polyol solution is mixed with a polyisocyanate just before use, and applied to the substrate. The coating then cures by chemical crosslinking to form a durable urethane bond. The cure speed and film properties can be tailored to the application by varying the hardness (T_{g}) and functionality (OH number) of the acrylic polyol; the isocyanate, type of solvents used, accelerators and heat. This requires surface modification/dispersant/surfactant solutions, which may be achieved by silanization, ionic stabilization, or silica passivation steps. The method of deposition can be large format, roll-to-roll coating of the formulation on a flexible polymeric substrate using Meyer rod or slot die deposition.

Modification of the Thermochromic Transition Temperature

Through chemical doping with tungsten and other elements, the transition temperature can be tuned from 68° C. (150° F.) for undoped VO₂ to anywhere in the range of −15° C. to 80° C. (5° F. to 175° F.) for doped VO₂. Other dopants that can be used include niobium, tantalum, molybdenum, titanium, zirconium, hafnium, magnesium, copper, nickel, cobalt, chromium, aluminum, hydrogen, lithium, scandium, yttrium, germanium, and silicon. Typically, the dopant concentration is less than 15%, preferably between 1 and 10%.

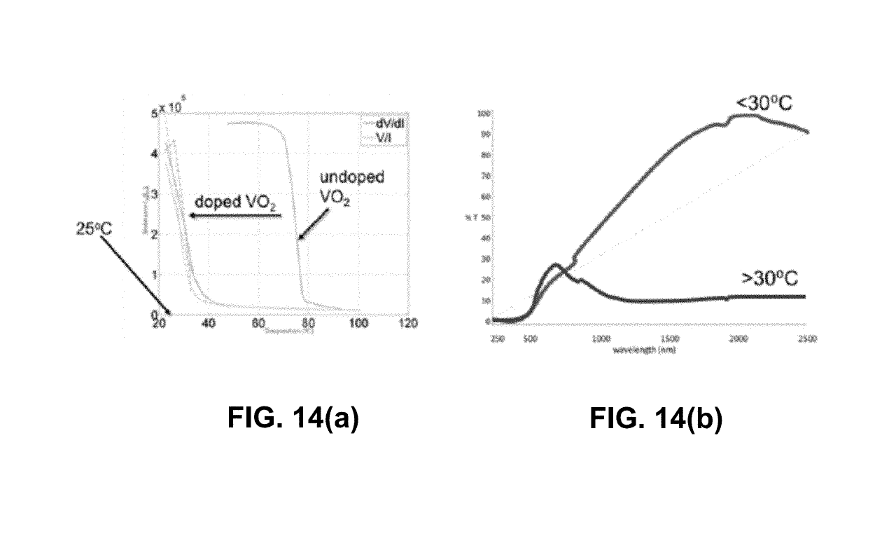

FIG. 14(a) shows shifting of transition to 25° C. (84° F.) through chemical doping, enabling warm and cold environmental control of infrared heat gain. FIG. 14(b) shows the transmission of this composition as a function of wavelength for cold (<30° C.) and warm (>30° C.) conditions, demonstrating similar daylight transmission at 400-700 nm visible wavelength, but a 70% to 80% decrease in infrared transmission from 1.0 micron to 2.5-micron wavelengths.

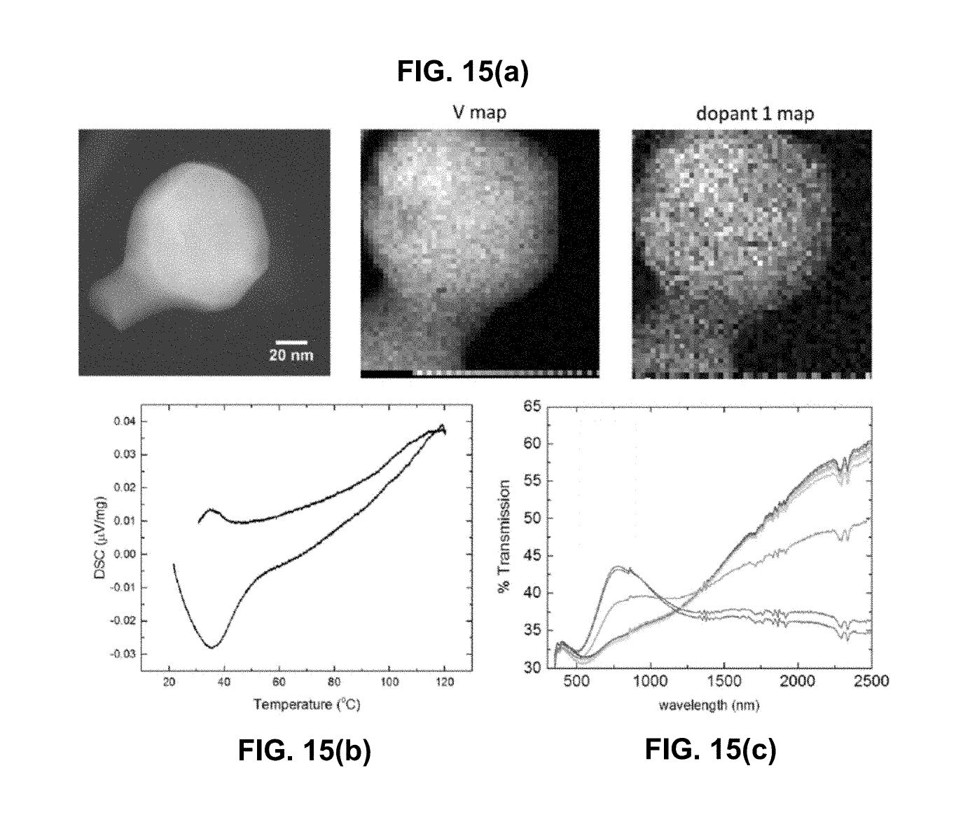

FIGS. 15(a), 15(b), and 15(c) show transmission electron microscopy (TEM), differential scale calorimetry (DSC), and optical transmission of multiply doped VO₂ nanoparticles, respectively. These figures demonstrate particle size below 60 nm, uniform chemical doping of particles, and environmental tuning of transmission of nanoparticles dispersed into polymer composite films. The transition temperature of films is tailorable from −15° C. to 80° C., and is located for these nanoparticles at 35° C. (95° F.) for demonstration of warm weather tunability of IR transmission. Doping is aimed at both transition temperature control and minimization of hysteresis on heating/cooling.

Accordingly, both the absorbance in the near-IR solar tail (700 nm to 2.5 microns) and the emissivity in the far-IR 8-12-micron emission peak for windows/buildings can be designed to be inherently low-e in the VO₂ insulator state and have tunable emissivity through use of a designed, environmentally triggered transition to metallic on hot days (e.g. transition at 20° C. to 35° C.) to trigger a high emissivity state.

The present invention has been described as a thermochromic low-emissivity film. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A thermochromic low-emissivity film, comprising:
a layer comprising vanadium dioxide, wherein the vanadium dioxide undergoes a metal-insulator transition at a thermochromic transition temperature, such that the layer transmits infrared radiation below the thermochromic transition temperature and reflects infrared radiation above the thermochromic transition temperature, and
a layer comprising a transparent conductive oxide,
wherein the thermochromic low emissivity film has an emissivity of less than 0.4 at a wavelength of 10 microns.

2. The thermochromic low-emissivity film of claim 1, wherein the layer comprising vanadium dioxide comprises a thin film of vanadium dioxide having a film thickness less than 300 nm.

3. The thermochromic low-emissivity film of claim 1, wherein the layer comprising vanadium dioxide comprises a plurality of vanadium dioxide nanoparticles dispersed in a first transparent polymer matrix.

4. The thermochromic low-emissivity film of claim 3, wherein the vanadium dioxide nanoparticles have a particle size smaller than 300 nm.

5. The thermochromic low emissivity film of claim 1, wherein the vanadium dioxide is doped.

6. The thermochromic low-emissivity film of claim 5, wherein the dopant comprises tungsten.

7. The thermochromic low-emissivity film of claim 5, wherein the dopant comprises niobium, tantalum, molybdenum, titanium, zirconium, hafnium, magnesium, copper, nickel, cobalt, chromium, aluminum, hydrogen, lithium, scandium, yttrium, germanium, or silicon.

8. The thermochromic low-emissivity film of claim 5, wherein the dopant concentration is less than 15%.

9. The thermochromic low-emissivity film of claim 3, wherein the first transparent polymer matrix comprises polyester, polyether, polyimide, polystyrene, or polyurethane.

10. The thermochromic low-emissivity film of claim 1, wherein the thermochromic transition temperature is between −15° C. and 80° C.

11. The thermochromic low-emissivity film of claim 1, wherein the transparent conductive oxide comprises In₂O₃, (In,Sn)₂O₃, fluorine-doped SnO₂, SnO₂, ZnO, CdO, Ga₂O₃, or (Ga,In,Zn)₂O₃.

12. The thermochromic low-emissivity film of claim 1, wherein the transparent conductive oxide has a plasma wavelength longer than 800 nm.

13. The thermochromic low-emissivity film of claim 1, wherein the layer comprising a transparent conductive oxide comprises a thin film of transparent conductive oxide having a film thickness less than 300 nm.

14. The thermochromic low-emissivity film of claim 1, wherein the layer comprising a transparent conductive oxide comprises a plurality of transparent conductive oxide nanoparticles dispersed in a second transparent polymer matrix.

15. The thermochromic low-emissivity film of claim 14, wherein the transparent conductive oxide nanoparticles have a particle size smaller than 300 nm.

16. The thermochromic low-emissivity film of claim 14, wherein the second transparent polymer matrix is transparent from 0.4 μm to 2.5 μm wavelength.

17. The thermochromic low-emissivity film of claim 14, wherein the second transparent polymer matrix comprises polyester, polyether, or polyurethane.

18. The thermochromic low-emissivity film of claim 1, further comprising a transparent polymer layer between the layer comprising vanadium dioxide and the layer comprising a transparent conductive oxide layer.

19. The thermochromic low-emissivity film of claim 18, wherein the transparent polymer layer is between 0.2 microns and 3 microns in thickness.

20. The thermochromic low-emissivity film of claim 18, wherein the transparent polymer layer is transparent from 0.4 μm to 2.5 μm wavelength.

21. The thermochromic low-emissivity film of claim 18, wherein the transparent polymer layer comprises polyester, polyether, polyimide, polystyrene or polyurethane.
